(19) United States
(12) Patent Application Publication
(10) Pub. No.: US 2018/0349352 A1
(43) Pub. Date: Dec. 6, 2018

(54) SYSTEMS AND METHODS FOR IDENTIFYING NEWS TRENDS

(71) Applicant: SOCIAL NETWORKING TECHNOLOGY, INC., Wichita, KS (US)

(72) Inventor: Venkatesh MABBU, Wichita, KS (US)

(21) Appl. No.: 15/861,956

(22) Filed: Jan. 4, 2018

Related U.S. Application Data
(60) Provisional application No. 62/442,553, filed on Jan. 5, 2017.

(51) Int. Cl. G06F 17/27; G06Q 50/00; G06F 17/28; G06Q 30/02

(52) U.S. Cl. CPC G06F 17/278; G06Q 30/0276; G06F 17/2881; G06Q 50/01

(57) ABSTRACT

Systems and methods for identifying news trends involve identifying trending entities in the collected articles based on entity weights and identifying trending topics in the collected articles based on entities and associated items. The identified trending topics or trending entities can be used to automatically inform publishers of the identified trending topics or trending entities, automatically select advertisements related to one or more of the identified trending topics or trending entities, automatically generate an article discussing one or more of the identified trending topics or trending entities, and/or automatically generate a website widget related to one or more of the identified trending topics or trending entities.

### BACKGROUND OF THE INVENTION

Exemplary embodiments of the present invention are directed to systems and methods for identifying news trends and using trending news.

The Internet is composed of a large number of web pages making enormous amounts of information available to anyone with an Internet connection. Many people are now relying primarily on the Internet for news compared to newspapers, magazines, radio, and television.

There are many ways to obtain news from the Internet. One common way is to visit a website dedicated to news, such as CNN, Fox News, the New York Times, etc. The placement of articles on web pages on these websites is typically a human editorial decision and may not necessarily reflect the most popular news items. Some news websites identify news stories trending on their own websites, which may not necessarily reflect overall news trends. For example, some news websites have particular partisan leanings and a news story trending on one of these websites may not actually be representative of a larger trend when other sources of news are considered.

Social media is quickly becoming another major source of news. In social media news is typically spread by a user posting an article, or a link to the article, appearing on another website. Social media websites also provide news in the form of trending topics, which are based on topics popular on that particular social media website. Although this may indicate topics trending on the particular social media website it may not necessarily be representative of larger trends when other news sources are considered.

In addition, websites determining trends based on information collected from their own websites can be subject to bias due to human curation of the information by the website operators.

The large amount of information on the Internet has resulted in many people considering there to be too much information available and not enough time to consume all desired information. This is likely one driver behind the rise of Twitter®, which limits posts to 140 characters or less. Using such a service a person can quickly consume large amounts of different types of information because each individual information item is limited to 140 characters or less.

### SUMMARY OF THE INVENTION

Accordingly, it would be desirable to provide systems and methods for identifying trending topics and entities that are more representative of overall trending topics and entities. It would also be desirable to provide systems and methods for identifying trending topics and entities that are not subject to human curation or other biases. Furthermore, it would be desirable to provide another use for the information generated during the identification of trending topics and entities.

A method according to an aspect of the invention involves collecting a number of articles, identifying trending entities in the collected articles based on entity weights, and identifying trending topics in the collected articles based on entities and associated items. The identified trending topics or trending entities can be used to automatically inform publishers of the identified trending topics or trending entities, automatically select advertisements related to one or more of the identified trending topics or trending entities, automatically generate an article discussing one or more of the identified trending topics or trending entities, automatically select an article discussing one or more of the identified trending topics or trending entities, or automatically generate a website widget related to one or more of the identified trending topics or trending entities.

Another method according an aspect of the invention involves collecting a number of articles and identifying trending entities in the collected articles based on entity weights. The trending entities are identified by identifying all entities in each of the number of collected articles, generating weights for each of the identified entities, and selecting a number of the identified entities having a highest weight as representing trending entities. The identified trending entities can be used to automatically inform publishers of the identified trending entities, automatically select advertisements related to one or more of the identified trending entities, automatically generate an article discussing one or more of the identified trending entities, automatically select an article discussing one or more of the identified trending topics or trending entities, or automatically generate a website widget related to one or more of the identified trending entities.

Yet another method according to an aspect of the invention involves collecting a number of articles and identifying trending topics in the collected articles based on entities and associated items. Trending topics are identified by, for each of the number of collected articles, identifying the entities and the associated items in a portion of the selected article, full-text searching of the identified entities and associated items against a database of the collected number of articles to identify matching articles, and generating a score based on a number of matching articles. Each of the number of collected articles is ranked based on the score generated for each of the number of articles and a number of collected articles are selected having a highest score as representing trending topics. The identified trending topics can be used to automatically inform publishers of the identified trending topics, automatically select advertisements related to one or more of the identified trending topics, automatically generate an article discussing one or more of the identified trending topics, automatically select an article discussing one or more of the identified trending topics or trending entities, or automatically generate a website widget related to one or more of the identified trending topics.

Another method according to an aspect of the invention involves identifying trending entities in collected articles based on entity weights, identifying trending topics in the collected articles based on entities and associated items, and using the identified trending topics or trending entities to automatically generate an article discussing one or more of the identified trending topics or trending entities. The article is automatically generated by identifying keywords in a title of an article containing one of the trending topics or trending entities, identifying sentences in a body of the article containing one of the trending topics or trending entities having words matching the identified keywords, weighting each of the identified sentences based on number of matches between words in the sentence and the identified keywords and a location of the respective sentence in the article containing one of the trending topics or trending entities, and automatically generating the article by selecting sentences of the article based on the weighting of each of the identified sentences.

### BRIEF DESCRIPTION OF THE DRAWING FIGURES

FIG. 1 is a block diagram of an exemplary system in accordance with the present invention;

FIG. 2 is a flow diagram of an exemplary method for identifying trending entities and topics and using the identified trending entities and/or topics in accordance with the present invention;

FIG. 3 is a flow diagram of an exemplary method for collecting and indexing news in accordance with the present invention;

FIG. 4 is a flow diagram of an exemplary method for identifying trending entities in accordance with the present invention;

FIG. 5 is a flow diagram of an exemplary method for categorizing trending articles in accordance with the present invention;

FIG. 6 is a block diagram of an exemplary method for identifying trending topics in accordance with the present invention;

FIG. 7 is a flow diagram of an exemplary method for automatically generating an article in accordance with the present invention; and

FIG. 8 illustrates an exemplary article and summary article in accordance with the present invention.

### DETAILED DESCRIPTION

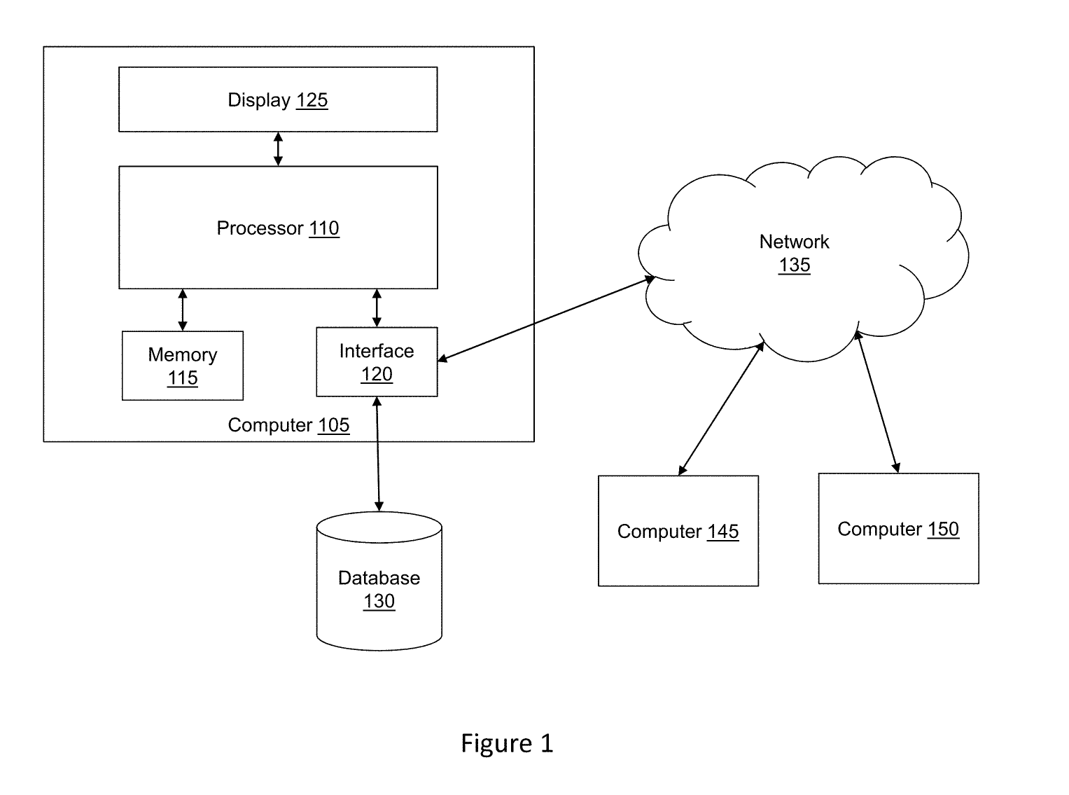

FIG. 1 is a block diagram of an exemplary system in accordance with the present invention. The system includes a computer 105 coupled to one or more other computers 145 and 150 via a network 135, such as the Internet. As will be described in more detail below, computer 105 performs the disclosed methods for, among other things, identifying trending topics and/or trending entities, automatically generating article summaries, and using the identified trending topics and/or trending entities in accordance with the present invention. Computers 145 and 150 can be servers hosting web pages and/or one of these computers can be an end-user computer that is provided with the results of the identification of trending topics and/or trending entities. Computers 105, 145, and 150 can be any type of computer, including desktop computers, laptop computers, tablets, smart phones, etc.

Computer 105 includes one or more interfaces 120 for communicating with Internet servers, which can be any type of wireless and/or wired interface. Interface 120 is coupled to processor 110, which is coupled to one or more memories 115 in order to, among other things, perform the disclosed methods. Processor 110 can be any type of processor, including a microprocessor, field programmable gate array (FPGA), application specific integrated circuit (ASIC), and/or the like.

Processor 110 is also coupled to one or more displays 125. The display 125 can take the form of any type of display and can be internal or external to computer 105.

Memory 115 can include any type of memory, including random access memory (RAM), read-only memory (ROM), a solid state hard drive (SSD), a spinning hard drive, and/or the like. Further, some of the memory 115 can be external to the computer 105. For example, computer 105 can be coupled to one or more databases 130 via interface 120. Memory 115 can store, among other things, computer-readable code for performing the methods of the present invention. For example, memory 115 can include a non-transitory computer readable medium containing such code.

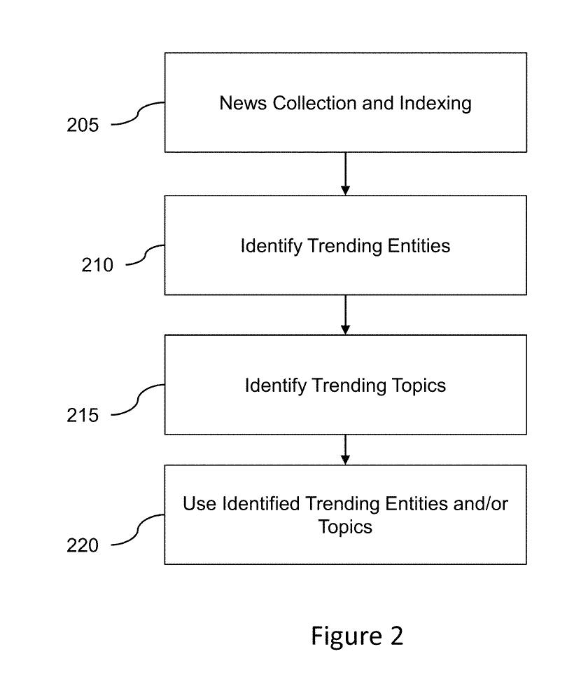

FIG. 2 is a flow diagram of an exemplary method for identifying trending entities and topics and using the identified trending entities and/or topics in accordance with the present invention. Initially, processor 110 collects and indexes news (step 205). Processor 110 then processes the indexed news to identify trending entities (step 210) and trending topics (step 215). Entities are proper nouns and topics are categorizations of the type of content expected in the story of an article. Processor 110 can then use the trending entities and/or topics in a number of different ways (step 220).

Publishers/bloggers could use the identified trending entities and/or topics as a research tool to determine detailed insights about their own data, such as tracking whether their articles are directed to any of the trending entities and/or topics, or generating news articles about the trending entities and/or topics. This can be performed by maintaining a list of publishers/bloggers interested in this service and automatically sending a list of identified trending entities and/or topics to the publishers/bloggers. If the publishers' and/or bloggers' websites are indexed as part of this method then a report can also be automatically sent that identifies the trending topics and/or trending entities that also appear on the particular publisher's/blogger's website and/or sending a report identifying trending topics and/or trending entities that do not appear on the particular publisher's/blogger's website.

The tending entities and/or topics can also be used for automatically selecting advertisements. For example, if the topic “Black Friday” is tending on the Internet then an advertisement related to Black Friday deals could selected as an advertisement on a web page. Similarly, if the entity “Clippers” is trending then an advertisement for a web page can be selected that offers for sale Los Angeles Clippers' paraphernalia, such as t-shirts and hats. These advertisements can be displayed, for example, using web widgets as described in U.S. Provisional Application Nos. 62/372,821, 62/372,822, and 62/372,823, all of which were filed on Aug. 10, 2016, and all of which are herein expressly incorporated by references. For example, the web widgets can be programmed to automatically receive trending topics and/or trending entities and then select advertisements related to the received trending topics and/or trending entities.

The real-time trending entities and/or topics can also be shared with makers of advertisements so that this information can be shared with their customers and used for more effective advertisements. For example, advertisements can be customized to be more relevant to the trending entities and/or topics, which may increase the effectiveness of the advertisements. The advertisement makers and their customers can then provide their advertisement networks with advertisements related to trending entities and/or topics.

Moreover, the trending entities and/or topics can be used to identify lists that can be automatically generated and displayed on a web page alongside the advertisements or by themselves using the techniques disclosed in the aforementioned provisional applications to automatically receive the list of trending entities and/or topics and then select lists relevant to the trending entities and/or topics. Alternatively or additionally, the trending entities and/or topics can be used to identify articles (either human- or machine-generated) that can be displayed on a web page alongside the advertisements or by themselves using the techniques disclosed in the aforementioned provisional applications.

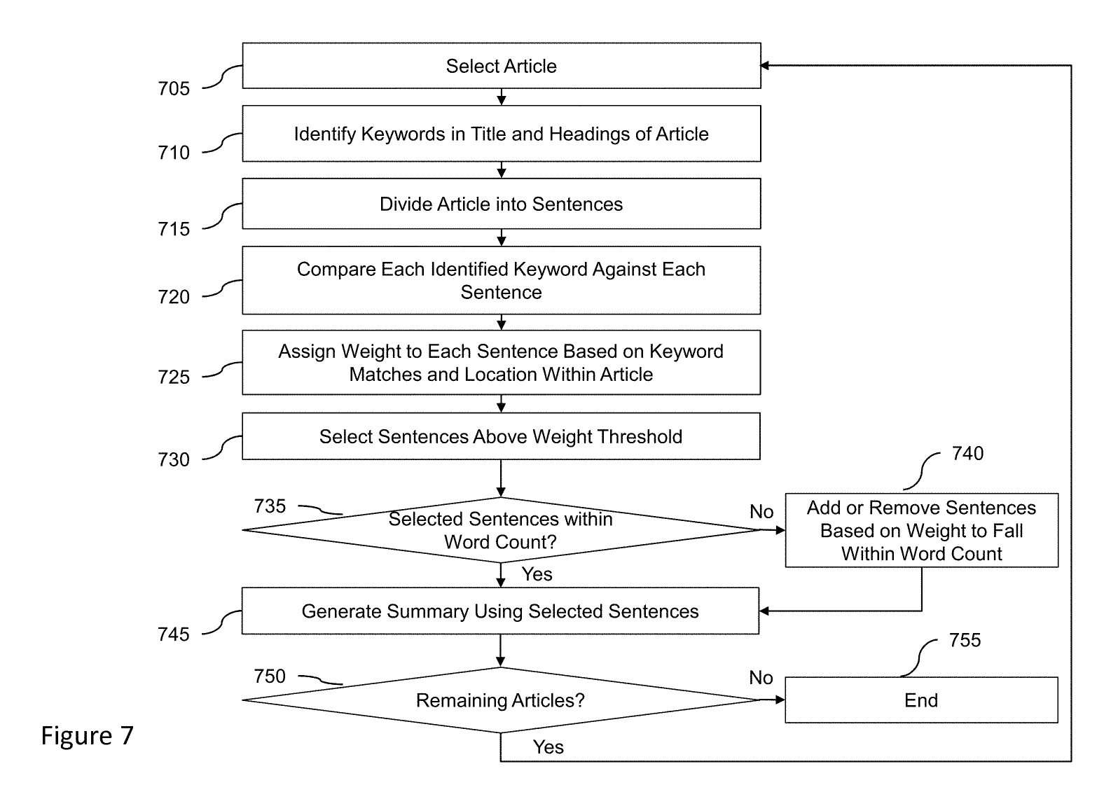

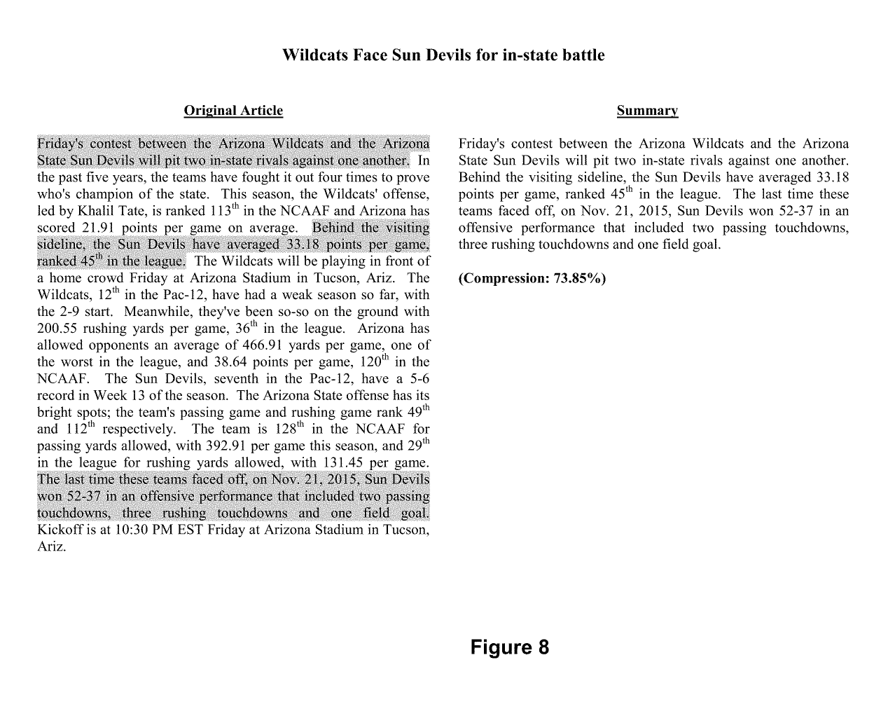

The trending entities and/or topics can also be used to automatically generate articles directed to the trending entities and/or topics, which will be described in more detail below in connection with FIGS. 7 and 8. Focusing automatic article generation on trending entities and/or topics helps a website increase viewership, obtain better search engine ranking, and brings more traffic to the website. The trending entities and/or topics can also be used to automatically select human-generated articles directed to the trending entities and/or topics for display on a web page.

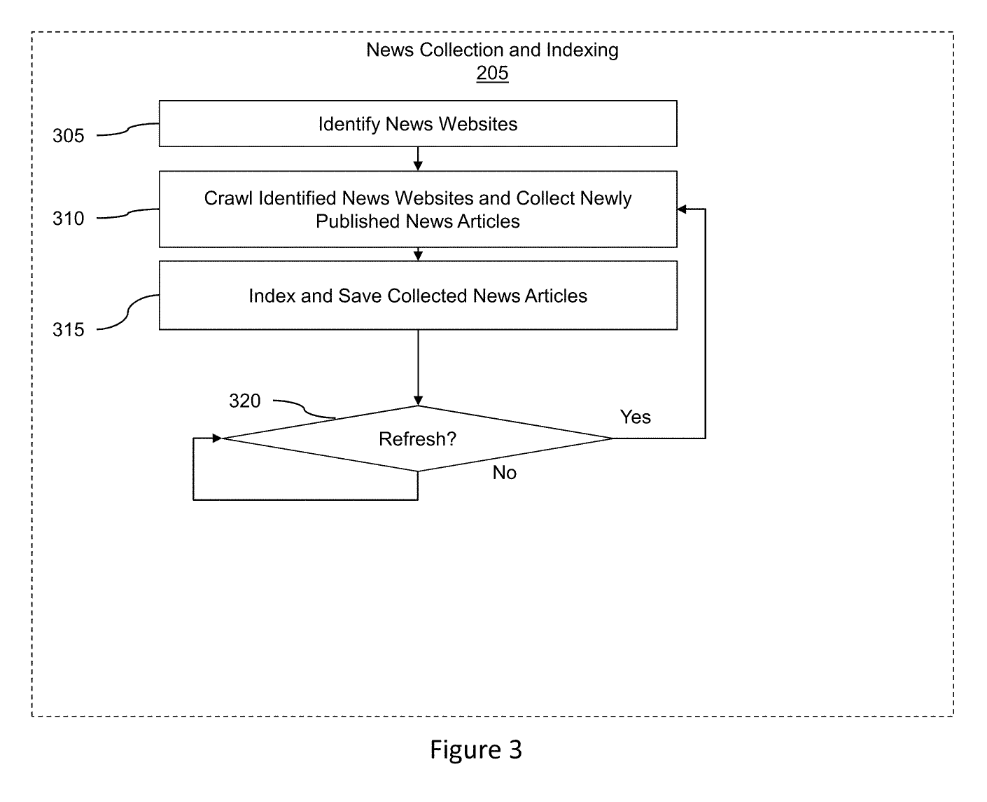

Now that an overview of the overall method of the present invention has been provided, details of the method will be provided in connection with FIGS. 3-8.

FIG. 3 is a flow diagram of an exemplary method for collecting and indexing news in accordance with the present invention. Initially, processor 110 identifies news websites (step 305) and initiates/sends a web spider that then crawls the identified news websites and collects newly published news articles from the associated web pages (step 310). The use of web spiders in this manner is common, and therefore a detailed explanation as the skilled artisan can make and use a web spider in this manner without undue experimentation. Processor 110 then indexes the collected news articles and saves the indexed news articles in memory 115 and/or database 130 (step 315). Next processor 110 determines whether a refresh time has passed (step 320), and when it has (“Yes” path out of decision step 320), processor 110 initiates/sends the web spider to crawl the identified news websites again (step 310). Alternatively, when a refresh time has passed processor 110 can check to see if any new websites are identified before beginning the crawling again.

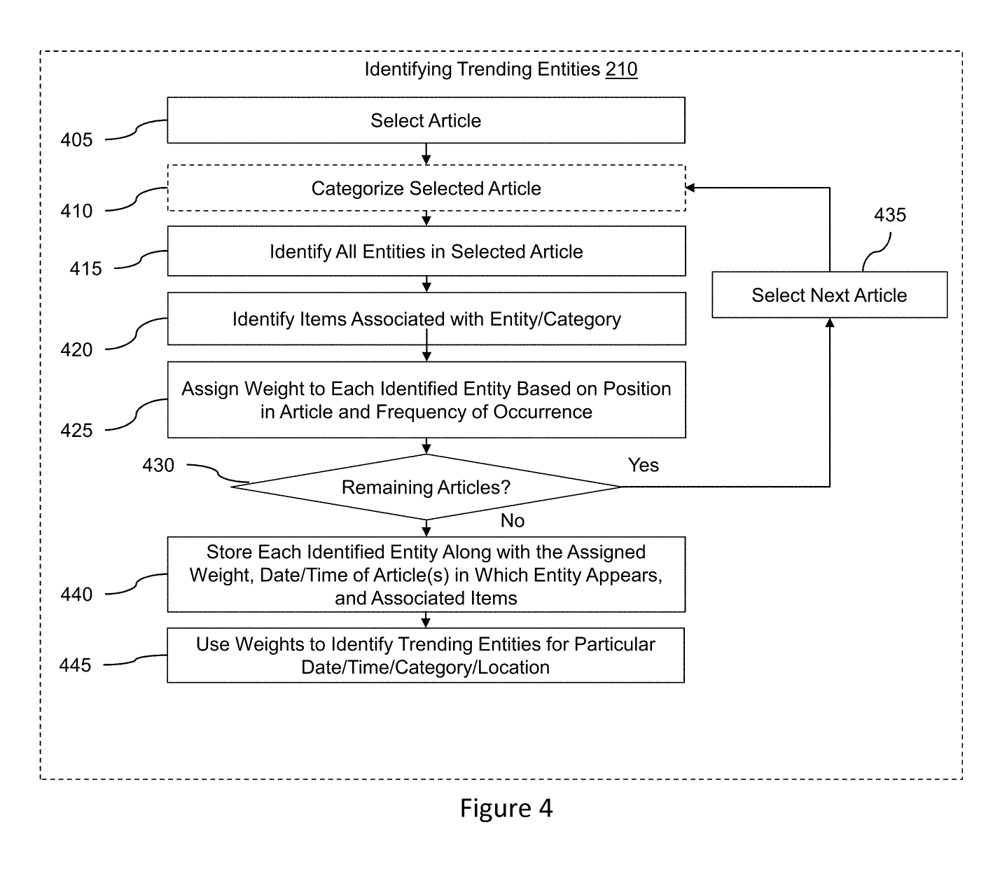

FIG. 4 is a flow diagram of an exemplary method for identifying trending entities in accordance with exemplary embodiments of the present invention. Processor 110 initially selects one of the collected and indexed articles (step 405) and categorizes the selected article by parsing and interpreting the content of the article (step 410). As illustrated by the dashed lines around step 410, categorization is an optional step and can be omitted if categorization is not desired for trending entities.

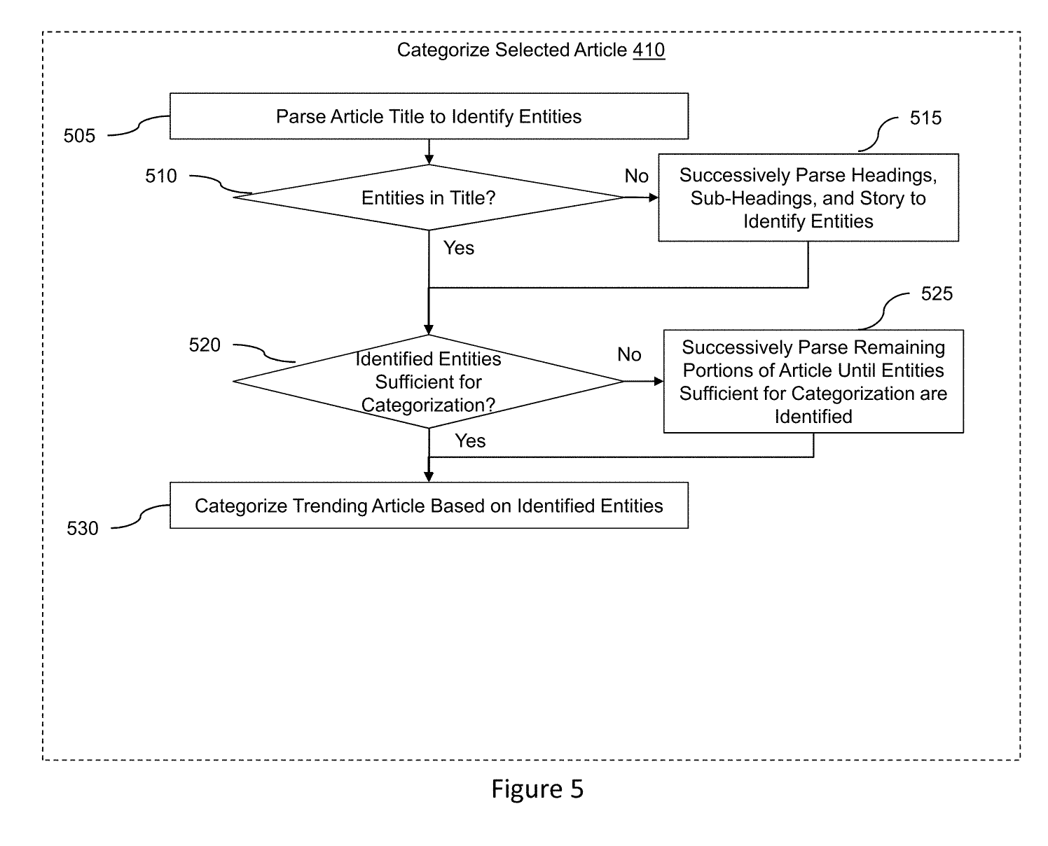

FIG. 5 illustrates an exemplary method for categorizing trending articles in accordance with the present invention. Initially, processor 110 parses the article title to identify entities (step 505). Thus, for example, if the title of the article is “Clippers blow 15-point lead in 111-102 loss to Pacers” then “Clippers” are identified as the entity “Los Angeles Clippers” and Pacers are identified as the entity “Indiana Pacers”. If there are no entities in the title (“No” path out of decision step 510), then processor 110 successively parses headings, sub-headings, and the story itself until entities are identified (step 515).

If there are entities in the title (“Yes” path out of decision step 510) or after entities are found in one of the headings, sub-headings, or story itself (step 515), processor 110 determines whether the identified entities are sufficient for categorization. This determination can be performed using categorized facts stored in memory 115 and/or database 130. If the identified entities are not sufficient for categorization (“No” path out of decision step 520), then processor 110 continues to parse the remaining portions of the article until entities sufficient for categorization are identified (step 525). It will be recognized that even if the title, header(s), and sub-heading(s) do not contain entities sufficient for categorization, the story itself will.

After entities sufficient for categorization are identified (“Yes” path out of decision step 520 or after step 525), processor categorizes the trending articles based on the identified entities (step 530).

Continuing the example above, the entities “Clippers” and “Pacers” are both National Basketball Association (NBA) teams, and this should be sufficient to categorize the article as “Sports”. Using the stored categorized facts this could be achieved by determining that the stored categorized facts identify both “Clippers” and “Pacers” as basketball teams and basketball as a sport.

An alternative technique for categorizing articles that can be employed with the present invention is to use lists, such as the techniques disclosed in U.S. Provisional application 62/423,388, filed Nov. 17, 2016, the entire content of which is herein expressly incorporated by reference.

Returning to FIG. 4, after the selected article is categorized (step 410), processor 110 then identifies all entities in the selected article (step 415). Processor 110 can reuse the entities identified for categorization to the extent that certain portions of the article have already been processed. Thus, for example, if the title and heading were processed to identify headings for categorization (step 410), these entities can be reused and then the sub-headings and story itself can be processed to identify any remaining entities.

Next, processor 110 identifies items associated (i.e., related terms) with the identified entities and/or category (step 420). Using the example above, the entities “Clippers” and “Pacers” were identified and associated with the sport basketball, and accordingly associated items could link terms or phrases such as “point”, “loss”, “lead”, “alley-oop”, “buzzer beater”, “cherry-picking”, “pick and roll”, etc. In the example above the associated items in the title would include “point”, “lead” and “loss”. The entities and identified associated items are later used for during the identification of trending topics, which is described in more detail below.

Another example can be an article with the title “Good news for Asthma patients, new inhaler relieves patients from cough and difficulty in breaking in seconds.” In this example “Asthma” is an entity and the associated items would include “inhaler”, “patients”, “cough”, and “breathing”.

After identifying the associated items (step 420), processor 110 then assigns weights to each identified entity based on position in the article and frequency of occurrence (step 425). An exemplary weight distribution, which could be modified as desired, can be:

| Location of Entity in Article | Weight |
|---|---|
| Page Title | 40% |
| Meta Description | 20% |
| <h1> tag | 20% |
| <h2> tag | 10% |
| <h3> tag | 5% |
| <p>, <div>, <span> tag | 3% |
| Entire document in plaintext | 2% |

Those skilled in the art will recognize the <p>, <div>, and <span> tags identify parts of the text story. The occurrence of entities in connection with these tags is calculated. The entire document in plaintext is the document after the HTML tags have been stripped from the document. A weighting example could involve the entity “Clippers” appearing in the Title, Meta Description, <h1> tag, and a single occurrence in the <p> tag. Accordingly, the weight for the page would be 83% (i.e., 40%+20%+20%+3%). It should be recognized that this weighting technique is merely exemplary and other weighting techniques can be used.

Processor 110 then determines whether there are any remaining articles (step 430), and if so (“Yes” path out of decision step 430) processor 110 selects the next article (step 435) and repeats the processing discussed above (steps 410-425). When there are no remaining articles to process (“No” path out of decision step 430), processor 110 stores each identified entity along with the assigned weight, date/time of the article in which the entity appears, and the associated items in memory 115 and/or database 130 (step 440). Although the storage is described as a step performed after all of the articles have been processed, this storage can occur concurrent with any of the earlier processing steps.

Finally, processor 110 uses the weights to identify trending entities for a particular date/time/category/location (step 445). This can be achieved by adding individual entity scores in each article to determine a final trending score for each entity. In order to appreciate how this is performed, first assume 20,000 articles are obtained and processed, 5,000 of which belong to the “Sports” category and 400 belong to the “Basketball” category. According to exemplary embodiments the frequency of each entity on all articles in the “Basketball” category is used to calculate its trending position in the “Basketball”, “Sports”, and “Overall” categories. Thus, if the entity “Clippers” appears in 20 documents with an average weight of 50 the cumulative weight would be 10 (i.e., 20*50%) and if the entity “Pacers” appears in 15 documents with an average weight of 80 the cumulative weight would be 12 (i.e., 15*80%). Accordingly, an exemplary formula for implementing this cumulative weighting would be (Number of Documents in Which Entity Appears)*(Average Weight of Entity in the Number of Documents). The present invention can use other techniques for using the assigned weights to identify trending entities.

The identification of trending entities can be based on any one or more of date, time, category, and location using filters. Thus, for example, a query can be made for “Wichita Events”, which would return trending entities related to Wichita, Kans. Similarly, a query can be made for “Dallas Shopping”, which would return trending entities related to a “Shopping” category and the location Dallas, Tex. An example of a date filter could be “Date-Wise Trending News in New York”, which would return trending entities related to the location New York, with the returned entities ordered by date. Another date filter could be “Trending Entities in California This Week”, which would return entities trending in California over the past week, ordered by weight over the past week.

As discussed above, the categorization step can be omitted, if desired. This omission may be made to increase the speed of processing the articles and reduce processing load in view of possible miscategorization or failure to categorize one or more articles. For example, an article about “School Bus Crashes in Chattanooga” may be classified as relating to the city “Chattanooga” and the category of “School”, whereas the overall focus of the article may be about criminal acts related to the crash, and thus the article should be categorized in the “Crime” category. One reason this may occur is that the driver of the school bus may not be generally known, and thus subject to categorization (in contrast to an article about Charles Schumer, who is a well-known United States Senator, and therefore articles containing his name can be easily categorized as related to “Politics”).

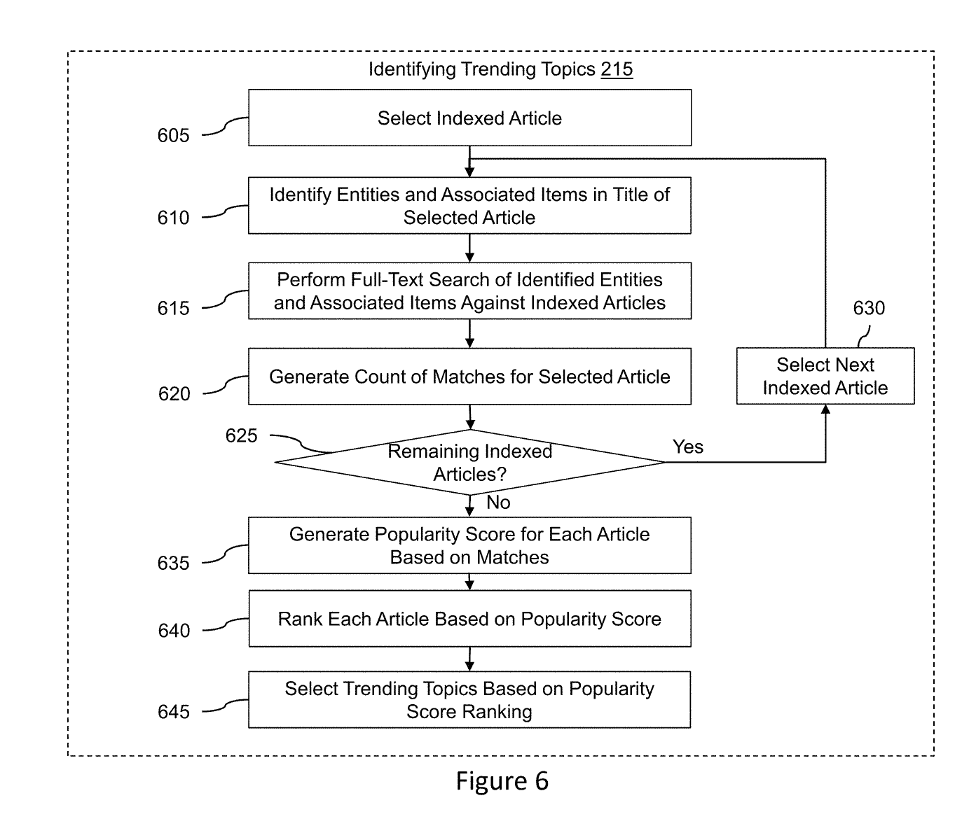

After the trending entities are identified (step 210), trending topics are identified (step 215) in accordance a method illustrated by the block diagram of FIG. 6. Processor 110 initially selects an indexed article (step 605) and identifies entities and associated items in the title of the selected article (step 610). Processor 110 can process each article anew or if the entities and associated items are stored in a manner corresponding to each article, processor 110 can use the results from previous processing in this step. Next, processor 110 performs a full-text search of entities and associated items identified in the selected article against the indexed articles (step 615) and counts the number of matches (step 620).

An example of implementing these steps will now be presented. Assume the title of the first selected article is “Trump Says He Will be Leaving His Business to Focus on Presidency.” The proper noun “Trump” is identified as the entity “Donald Trump” and the associated items would be “business” and “presidency”. A search of the article database for the terms “business/company/companies”, “presidency”, and “Trump/Donald Trump” could result in identifying articles with the following titles:

“Trump Says He's Leaving Business to Focus on Presidency”

“Trump to Leave his Business in Order to Focus on Presidency”

“Trump Says He's Leaving business to Avoid Conflicts”

“Trump Vows to Step Down from Company to Focus on Presidency”

“Donald Trump Says He's Leaving His Business ‘In Total’”

“Donald Trump: ‘I Will Be Leaving My Great Business”

“Trump Tweets that He's Leaving Business to Focus on Presidency”

Each of the indexed articles is processed in this manner (“Yes” path out of decision step 625, step 630, and steps 610-620) until all indexed articles are processed (“No” path out of decision step 625). Processor 110 then generates a popularity score for each article based on the number of matching articles (step 635). Any article with two or matches is treated as a trending article. Processor 110 then ranks each article based on the popularity score (step 640) and selects trending topics based on the ranked popularity scores (step 645). Similar to trending entities, trending topics can be selected based on a variety of filters in addition to popularity, including date/time/category/location. Thus, a query can be for “New York Trending News in the Past Month” can return the top trending topics related to New York in the past month, ordered based on popularity scores.

Now that trending entities and topics have been identified (steps 210 and 215), the results can be used a in variety of manners, such as the automatic generation of an article, and example of which will now be described in connection with FIGS. 7 and 8. Initially, processor 110 selects an article (step 705), such as an article that has a top trending entity and/or topic. Processor 110 then identifies keywords in the title and headings of the article (step 710). The keywords employed in article generation can be entities and associated items discussed above. Processor 110 divides the articles into sentences (step 715) and compares each identified keyword against each sentence (step 720). Processor 110 assigns a weight to each sentence based on keyword matches and the location of the keyword within the article (step 725). Any type of weighting scheme can be employed, such as assigning higher weights to matches occurring earlier in the article compared to matches occurring later in the article.

Processor 110 then selects sentences above a predetermined weight threshold (step 730) and determines whether the total number of words in the selected sentences is within a desired word count (step 735). When the selected sentences are not within the desired word count (“No” path out of decision step 735), sentences are added or deleted based on weighting until the total number of words is within the word count (step 740). The word count can be a range with both a maximum and minimum number of words. Once the selected sentences contain a cumulative total number of words within the word count (“Yes” path out of decision step 735 or after step 740), processor 110 generates a summary using the selected sentences (step 745). Processor 110 then determines whether any additional articles should be generated (step 750) and either ends the processing of generating articles (step 755) or selects another article for processing (step 705).

FIG. 8 illustrates an example of article generation with the original article on the left and the generated article on the right. As illustrated, the sentences having the sufficient weighting are highlighted in the original article and appear in the same order in the generated article on the right. As will be appreciated, each highlighted sentence includes words matching those in the title. The first highlighted sentence includes the matching words “Wildcats” and “Sun Devils”; the second highlighted sentence includes the word “Sun Devils”; and the third highlighted sentence includes the word “Sun Devils”. The first highlighted sentence is selected because it includes two words matching keywords in the title and is the first sentence in the article (as described above, the weighting accounts for the location of the sentence in the article). The second highlighted sentence is selected because it has one word matching a title keyword, it occurs early within the article, and the length of the sentence allows the summarized article to fit within the desired word count. The second highlighted sentence is selected over the immediately preceding sentence (which also occurs early in the article and contains one title keyword match) due to the second highlighted sentence being shorter than the one immediately preceding it, which allows the generated article to fit within the word count. The third highlighted sentence is selected over others due to its keyword match, location, and the word count allowing the generated article to stay within the desired word count.

The automatic article generation can be performed completely independently of the identification of trending entities/topics, if desired. Alternatively, articles can be automatically generated using the methods described above using any entities, topics, keywords and then after trending entities and/or topics are identified, the identified trending entities and/or topics can be used to select one of the previously, automatically generated articles for display on a web page. Another alternative could be to automatically generate articles from those collected and indexed as part of the web crawling and use these as the basis for identifying trending entities and/or topics. This would increase the overall processing speed and reduce processing load when identifying trending entities and/or topics because the automatic article generation results in a summarization of the original article that eliminates a lot of the “noise” that appears on the web page, such as advertisements, widgets, links, related articles, sponsored stories, etc.), and thus the process for identifying trending entities and/or topics can focus on those sentences from the original article having the right keywords that are useful for identifying trending entities and/or topics.

Another method of output, which is not illustrated, can be to use the categorized web page, either alone or in combination with other categorized web pages, to generate list widgets, such as those disclosed in U.S. Provisional Application Nos. 62/372,821, 62/372,822, and 62/372,823, all of which were filed on Aug. 10, 2016, and all of which are herein expressly incorporated by reference. Further, the present invention can also use the web page categorization to select advertisements for display that are relevant to the categorized web page, as also disclosed in the afore-mentioned provisional applications.

Although exemplary embodiments have been described in connection with matching single words, the present invention can also be implemented by matching phrases (i.e., more than one word). For example, the words “perfect” and “game” individually do not provide an indication that the web page relates to baseball, whereas the phrase “perfect game” is a common baseball term denoting a game where a pitcher does not allow any hits or runs. In this case the present invention can search for matching phrases in addition to, or as an alternative to, searching for matching terms.

Although exemplary embodiments are described in connection with identifying trending entities and topics using articles on web pages, the present invention can also be employed to categorize any type of digital file in any format, including word processing documents, eXtensible Markup Language (XML) files, etc.

Exemplary embodiments have been described above as automatically performing certain actions. If desired, any one of these actions can be performed manually.

The present invention is directed to addressing problems arising in the Internet, and thus the present invention is necessarily rooted in computer technology that solves problems unique to the Internet.

Although the present invention has been described above by means of embodiments with reference to the enclosed drawings, it is understood that various changes and developments can be implemented without leaving the scope of the present invention, as it is defined in the enclosed claims.

What is claimed is:

1. A method, comprising:
collecting a number of articles;
identifying trending entities in the collected articles based on entity weights;
identifying trending topics in the collected articles based on entities and associated items; and
using the identified trending topics or trending entities to
automatically inform publishers of the identified trending topics or trending entities,
automatically select advertisements related to one or more of the identified trending topics or trending entities,
automatically generate an article discussing one or more of the identified trending topics or trending entities,
automatically select an article discussing one or more of the identified trending topics or trending entities, or
automatically generate a website widget related to one or more of the identified trending topics or trending entities.

2. The method of claim 1, wherein the collection of the number of articles comprises:
automatically crawling across a number of website to obtain the number of articles; and
indexing each of the number of obtained articles based on information contained within each of the number of obtained articles.

3. The method of claim 1, wherein the identification of trending entities comprises:
identifying all entities in each of the number of collected articles;
generating weights for each of the identified entities; and
selecting a number of the identified entities having a highest weight as representing trending entities.

4. The method of claim 3, wherein prior to identifying all entities in each of the number of collected articles, the collected articles are categorized into article categories.

5. The method of claim 3, wherein the weights are generated based on a location of the identified entities within one or more of the collected articles.

6. The method of claim 5, wherein the weights are further generated based on a quantity of the number of collected articles in which the identified entities appear.

7. The method of claim 1, wherein the identification of trending topics comprises:
for each of the number of collected articles
identifying the entities and the associated items in a portion of a selected article;
full-text searching of the identified entities and associated items against a database of the collected number of articles to identify matching articles; and
generating a score based on a number of matching articles;
ranking each of the number of collected articles based on the score generated for each of the number of articles; and
selecting a number of collected articles having a highest score as representing trending topics.

8. The method of claim 7, wherein the selection of the number of collected articles having a highest score comprises:
selecting all articles having a score above a threshold value.

9. The method of claim 7, wherein the selection of the number of collected articles having a highest score comprises:
selecting a predetermined number of articles having highest scores.

10. The method of claim 7, wherein the identification of trending entities comprises identifying items associated with each entity in the collected articles, and the identified keywords are selected from the identified associated items.

11. The method of claim 1, wherein the generation of an article comprises:
identifying keywords in a title of an article containing one of the trending topics or trending entities;
identifying sentences in a body of the article containing one of the trending topics or trending entities having words matching the identified keywords;
weighting each of the identified sentences based on number of matches between words in the sentence and the identified keywords and a location of the respective sentence in the article containing one of the trending topics or trending entities; and
automatically generating the article by selecting sentences of the article based on the weighting of each of the identified sentences.

12. The method of claim 11, further comprising:
determining whether the automatically generated article is within a word count; and
automatically adding or removing sentences from the automatically generated article based on the determine of whether the automatically generated article is within the word count.

13. The method of claim 12, wherein the word count includes a minimum number of words and a maximum number of words.

14. A method, comprising:
collecting a number of articles;
identifying trending entities in the collected articles based on entity weights by
identifying all entities in each of the number of collected articles;
generating weights for each of the identified entities; and
selecting a number of the identified entities having a highest weight as representing trending entities
using the identified trending entities to
automatically inform publishers of the identified trending entities,
automatically select advertisements related to one or more of the identified trending entities,
automatically generate an article discussing one or more of the identified trending entities, automatically select an article discussing one or more of the identified trending topics or trending entities, or
automatically generate a website widget related to one or more of the identified trending entities.

15. The method of claim 14, wherein prior to identifying all entities in each of the number of collected articles, the collected articles are categorized into article categories.

16. The method of claim 14, wherein the weights are generated based on a location of the identified entities within one or more of the collected articles.

17. The method of claim 16, wherein the weights are further generated based on a quantity of the number of collected articles in which the identified entities appear.

18. The method of claim 14, wherein the collection of the number of articles comprises:
automatically crawling across a number of website to obtain the number of articles; and
indexing each of the number of obtained articles based on information contained within each of the number of obtained articles.

19. A method, comprising:
collecting a number of articles;
identifying trending topics in the collected articles based on entities and associated items by
for each of the number of collected articles
identifying the entities and the associated items in a portion of a selected article;
full-text searching of the identified entities and associated items against a database of the collected number of articles to identify matching articles; and
generating a score based on a number of matching articles;
ranking each of the number of collected articles based on the score generated for each of the number of articles;
selecting a number of collected articles having a highest score as representing trending topics; and
using the identified trending topics to
automatically inform publishers of the identified trending topics,
automatically select advertisements related to one or more of the identified trending topics,
automatically generate an article discussing one or more of the identified trending entities,
automatically select an article discussing one or more of the identified trending topics or trending entities, or
automatically generate a website widget related to one or more of the identified trending topics.

20. The method of claim 19, wherein the selection of the number of collected articles having a highest score comprises:
selecting all articles having a score above a threshold value.

21. The method of claim 19, wherein the selection of the number of collected articles having a highest score comprises:
selecting a predetermined number of articles having highest scores.

22. The method of claim 19, wherein the identification of trending entities comprises identifying items associated with each entity in the collected articles, and the identified keywords are selected from the identified associated items.

23. The method of claim 19, wherein the collection of the number of articles comprises:
automatically crawling across a number of website to obtain the number of articles; and
indexing each of the number of obtained articles based on information contained within each of the number of obtained articles.

24. A method, comprising:
identifying trending entities in collected articles based on entity weights;
identifying trending topics in the collected articles based on entities and associated items; and
using the identified trending topics or trending entities to automatically generate an article discussing one or more of the identified trending topics or trending entities by
identifying keywords in a title of an article containing one of the trending topics or trending entities;
identifying sentences in a body of the article containing one of the trending topics or trending entities having words matching the identified keywords;
weighting each of the identified sentences based on number of matches between words in the sentence and the identified keywords and a location of the respective sentence in the article containing one of the trending topics or trending entities; and
automatically generating the article by selecting sentences of the article based on the weighting of each of the identified sentences.
